(19) United States
(12) Patent Application Publication
(10) Pub. No.: US 2018/0089639 A1
(43) Pub. Date: Mar. 29, 2018

(54) SYSTEM AND METHOD FOR ROUTING ACH PAYMENTS INITIATED WITHIN VENDOR-DEFINED ACH PAYMENT SCHEMES

(71) Applicant: MASTERCARD INTERNATIONAL INCORPORATED, Purchase, NY (US)

(72) Inventor: Richard F. Crum, Ave Maria, FL (US)

(21) Appl. No.: 15/720,877

(22) Filed: Sep. 29, 2017

Related U.S. Application Data
(60) Provisional application No. 62/401,815, filed on Sep. 29, 2016.

(51) Int. Cl. G06Q 20/02; G06Q 20/10; G06Q 20/06; G06Q 30/06; G06Q 40/02

(52) U.S. Cl. CPC G06Q 20/023; G06Q 20/102; G06F 3/04812; G06Q 30/06; G06Q 40/02; G06Q 20/06

(57) ABSTRACT

The subject invention provides a system and method which permits routing of ACH payments between vendor-defined ACH payment schemes. The system generally includes one or more routing computing units located on an electronic payment network configured to electronically route ACH formatted messages.

### BACKGROUND OF THE INVENTION

Electronic cashless payments are well known in the prior art, including electronic payments across established networks. Automated Clearing House (ACH) payments are well known in the art and constitute electronic account-to-account payments across established payment networks, including the Automated Clearing House network.

ACH payments may be used as business-to-business payments to settle accounts payables between businesses, such as buyers and suppliers. ACH payments are based on transaction instructions in standard formatted messages, such as NACHA formatting, which include information necessary to allow for proper routing of payment. The transaction instructions are electronically routed over an electronic payment network, with the included instructions providing routing guidance. Additional details beyond amounts and destination bank and account information may be included in the transmitted transaction instructions, particularly in customizable data elements or characters included in the related messages. In addition, addenda files, such as in XML format, may be provided with included additional details.

ACH payments are limited in the amount of information includable in the base transaction messages. Thus, remittance data (e.g., related invoice numbers, reductions, charge-backs, etc.) are not included in the base transaction messages. Parties receiving ACH payments may lack information to fully reconcile received payments with outstanding accounts receivables.

Vendor-defined ACH payment schemes have been developed in the prior art which allow for relatively automated ACH payments to be made between businesses and for information to be conveyed to receiving parties beyond base transaction messages. These are schemes which utilize available electronic payment networks, such as the ACH electronic payment network, but with restricted access. With restricted access, central databases of company bank account information may be maintained, thereby allowing for relatively automated ACH payments to be made between businesses. ACH payments may be made with simple selection of destination payees, without need for sharing bank account information. In addition, details beyond base payment information may be provided. For example, systems practiced under the name “PAYMODE-X” (Bottomline Technologies (de), Inc.) and under the name “AVIDXCHANGE” (AvidXchange, Inc.) allow for relatively automated electronic account-to-account payments to be made between enlisted companies, with additional details regarding the payments being made available through on-line portals. Some of the schemes in the prior art may provide for one side of the transaction (i.e., outgoing payments or incoming payments) and some of the schemes may be “two-sided” solutions providing for both outbound and incoming payment facilitation. Overall, vendor-defined ACH payment schemes may be considered limited, as typically ACH payments are limited to parties enlisted in the schemes.

### SUMMARY OF THE INVENTION

The subject invention provides a system and method which permits routing of ACH payments between vendor-defined ACH payment schemes. The system generally includes one or more routing computing units located on an electronic payment network configured to electronically route ACH formatted messages. As used herein, “ACH formatted messages” are electronically transmittable strings of data elements or characters having predefined definitions to facilitate ACH payment; “ACH formatted messages” may be formatted in accordance with vendor or industry standards (e.g., NACHA) or formatted in accordance with standards established by an administrator or collaborator of the system of the subject invention. The routing computing units are configured to route ACH formatted messages between vendor-defined ACH payment schemes and from within vendor-defined ACH payment schemes to destination payees external thereof. As a result, the system of the subject invention allows for inter- and external vendor-defined ACH payment scheme payments to be made.

In addition, the system of the subject invention may include one or more databases listing available payees. The listing may be based on parties enlisted with, and, optionally, parties external to, vendor-defined ACH payment schemes associated with the one or more routing computing units. The database(s) allow for the routing computing unit(s) to conduct real-time look-ups of possible payees to determine if a desired ACH transaction may be completed.

Furthermore, one or more node computing units may be provided as intermediaries between the routing computing unit(s) and the vendor-defined ACH payment schemes. The nodes may be utilized both for data transfer and as intermediaries in settlement.

### BRIEF DESCRIPTION OF THE DRAWINGS

FIG. 1 is a schematic of a system formed in accordance with the subject invention;

FIGS. 2 and 3 depict a transaction data switch useable with the subject invention;

FIG. 4 depicts a database arrangement useable with the subject invention;

FIG. 5 depicts a settlement service useable with the subject invention; and,

FIG. 6 is a block diagram of a computing unit useable as any computing unit with the subject invention.

### DETAILED DESCRIPTION OF THE INVENTION

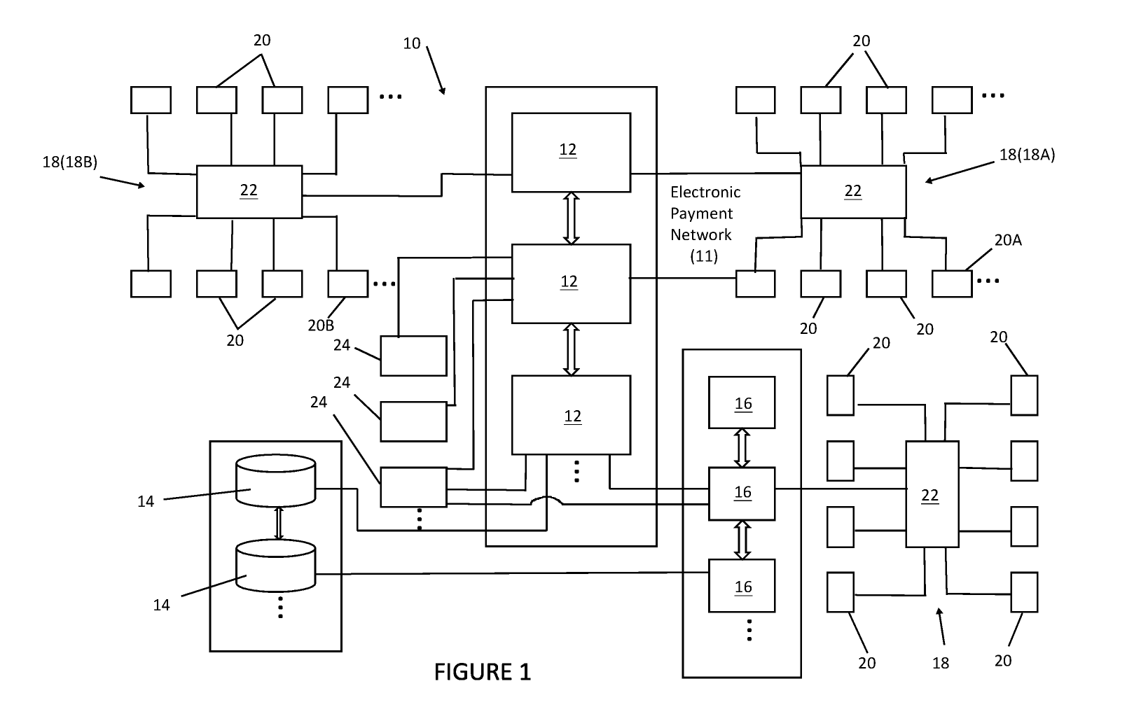

With reference to FIG. 1, a system 10 is shown which generally includes one or more routing computing units 12. Optionally, the system 10 may also include one or more databases 14 and/or node computing units 16. The system 10 is located on an electronic payment network 11 which may be larger than the system 10 (such as, for example, the ACH network, the Mastercard Payment Network, and VisaNet) configured to electronically route ACH formatted messages. The system 10, alternatively, may define its own (i.e., wholly contained) electronic payment network configured to route ACH formatted messages. It is understood that electronic payment networks are special purpose computer networks including hardware and software components configured to process ACH transactions, even in high volumes, in a secure manner, including the various processes of routing ACH formatted messages, authorizing, denying, settling, and so forth. Components of electronic payment networks are not publicly accessible.

The system 10 allows for routing of ACH payments between, and outside of, vendor-defined ACH payment schemes 18. The vendor-defined ACH payment schemes 18 are operated by various entities, typically as fee-based systems, which allow for generally automated ACH payments to pass between enlisted parties 20. The vendor-defined ACH payment schemes 18 may include one or more central computing units 22 which act as routing agents to facilitate ACH payment between the enlisted parties 20. The central computing units 22 are located on the electronic payment network 11 or an electronic payment network operatively connected to the electronic payment network 11. Banking information is stored on the central computing units 22, or on electronic memories or databases associated therewith. With the centrally stored banking details, the enlisted parties 20 do not require sharing of banking information to conduct ACH payments therebetween. Typically, ACH payments may be initiated by the enlisted parties 20 through log-in portals or other graphical user interfaces (GUI's) with selection of enlisted parties 20 via the central computing units 22 as payees to allow for ACH payment. ACH formatted messages are routed through the electronic payment network 11 to destinations defined by the vendor-defined ACH payment schemes 18, thus, restricting access to the schemes 18.

With reference to FIG. 1, the system 10 allows for ACH payments to be made outside of the related vendor-defined ACH payment schemes 18 by the enlisted parties 20. The routing computing units 12, which may be one or more computing units which may be physically or network connected, are electronically coupled with at least two of the vendor-defined ACH payment schemes 18 through the electronic payment network 11. In this manner, ACH formatted messages may be routed from one of the vendor-defined ACH payment schemes 18 (18A) to another vendor-defined ACH payment scheme 18 (18B) to allow for ACH payment to be made between enlisted parties 20 (20A, 20B) of the schemes 18A, 18B. The routing computing units 12 are configured to route ACH formatted messages on the electronic payment network 11 based on specified details. The routing computing units 12 may receive ACH formatted messages, from the one or more central computing units 22, which are initiated within the vendor-defined ACH payment schemes 18 by one or more of the enlisted parties 20.

As an additional option, the databases 14 may be provided, which are electronic databases provided with one or more of the routing computing units 12, with one or more of the node computing units 16 and/or as standalone components. Any database arrangement may be used. By way of non-limiting example, the databases 14 may be provided with one or more database management systems which include computing instructions to review stored data structures.

The databases 14 may include details of the vendor-defined ACH payment schemes 18, such as location details of the central computing units 22, and/or details of the enlisted parties 20. With an ACH formatted message being sent to the routing computing unit(s) 12, instructions may be provided to conduct a look-up of the databases 14 to ensure that the enlisted party 20 designated as a payee is in fact within the system 10 and eligible for payment. This will allow for control over payment between the vendor-defined ACH payment schemes 18, particularly by a party administering the routing computing units 12.

The node computing units 16 may be provided as one or more intermediaries between the routing computing units 12 and the vendor-defined ACH payment schemes 18 on the electronic payment network 11. The node computing units 16 may be configured for data routing and/or to conduct lookups via the databases 14. The node computing units 16 may be one or more computing units which may be physically or network connected.

The system 10 may allow for one or more direct parties 24 to participate who are not enlisted with any of the vendor-defined ACH payment schemes 18. The parties 24 may interface with the routing computing unit(s) 12 and/or the node computing unit(s) 16 through any GUI to allow for receiving or issuing ACH payments into or out of the vendor-defined ACH payment schemes 18 without the need for enlisting therein. Any portal or gateway into the electronic payment network 11 may be utilized by the parties 24.

Settlement of ACH payments may be passed through one or more of the components of the system 10, including over the electronic payment network 11. The electronic payment network 11 may be utilized in any known manner for facilitation of settlement of ACH payments. The node computing units 16 may be utilized to facilitate ACH payments to payees designated in the ACH formatted messages.

It is noted that within ACH formatted messages there may be variation, particularly in certain customized data elements. Thus, transmission of ACH formatted messages between the vendor-defined ACH payment schemes 18 may result in incomplete processing due to unrecognizable data elements. The system 10 may be configured to include a module which is associated with look-up tables to harmonize incoming ACH formatted messages to a predefined central standard or to modify the incoming ACH formatted messages to comply with an intended recipient scheme 18. In addition, or alternatively, a predefined ACH formatted message standard may be created to be used globally throughout the system 10 and the schemes 18.

The system 10 also may allow for additional information, such as remittance details, etc., to be transmitted with the ACH formatted messages. By way of non-limiting example, formatted addenda files, such as formatted in accordance with ISO 20022 (e.g., in XML format), may be transmitted with ACH formatted messages. This avoids the need for additional portal viewing or other external sources of information to convey additional information.

The database(s) 14 may be populated by details provided by the schemes 18, by information collected by an administrator of the routing computing units 14 and/or experientially based on actual users of the system 10.

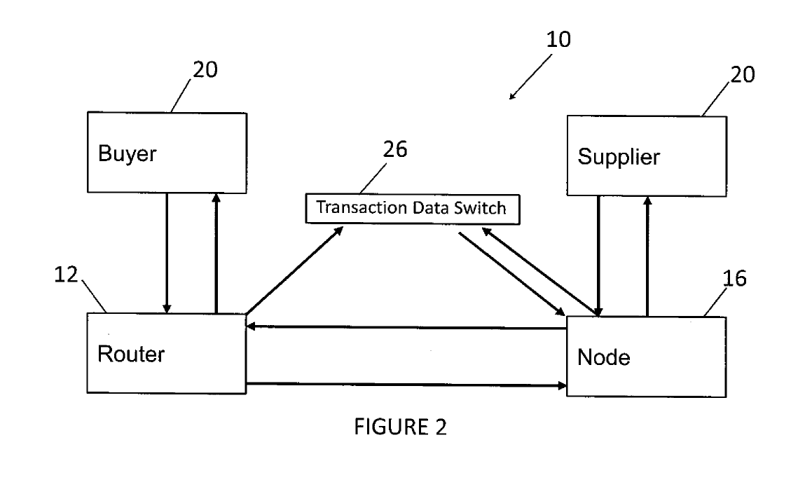

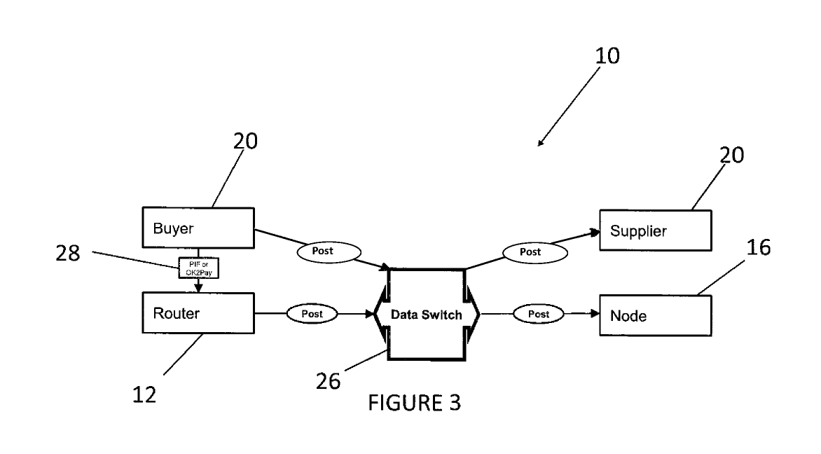

With reference to FIGS. 2 and 3, a transaction data switch 26 may be provided on the electronic payment network 11. A payment instruction file 28, which may include ACH formatted messaging, may be received by one or more of the routing computing units 12 from one or more of the enlisted parties (buyer, supplier) 20. The payment instruction file 28 includes remittance data in standardized format. The payment instruction file 28 may be posted to the data switch 26 by the routing computing unit 12 and routed therefrom to one of the node computing units 16 for payment execution to a designated payee.

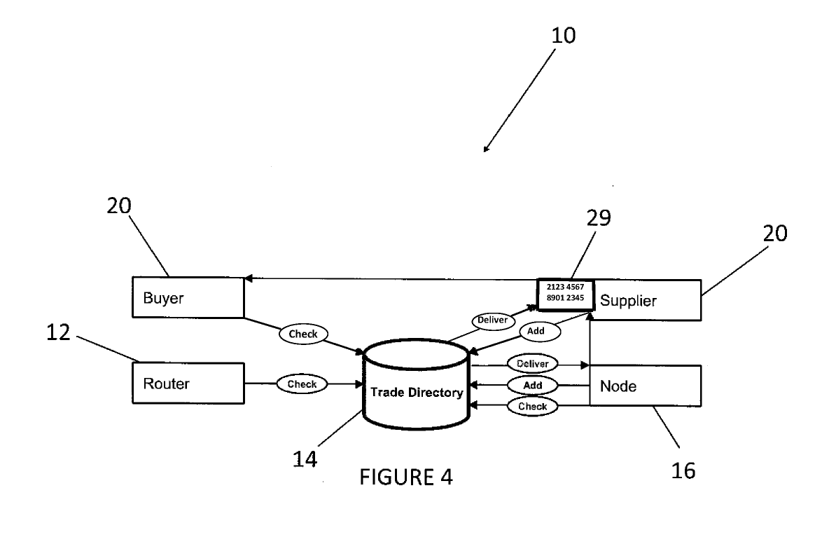

With reference to FIG. 4, the databases 14 may include payee data tokenized into account numbers. The tokenized account numbers are deliverable to the schemes 18, such as to any of the enlisted parties 20 and/or the central computing units 22 (as shown in FIG. 1), to use in initiating ACH payments. With the tokenized account numbers, ACH formatted messages may be routed without the need for inclusion of actual bank account numbers. This is similar to processing within the vendor-defined ACH payment schemes 18 where bank details are stored centrally with bank details not needing to be transmitted with an ACH payment request. The subject invention allows for the same functionality to be used by the enlisted parties 20 outside of their respective vendor-defined ACH payment schemes 18. With the tokenized account numbers, the ACH formatted messages may be transmitted without payee bank details, unlike standard ACH processing which requires such banking details. The ACH formatted messages with tokenized payee account details may be routed by the routing computing unit 12 to one of the node computing units 16, directly or via the transaction data switch 26, for payment execution. As shown in FIG. 4, the node computing units 16 may be operatively linked to the databases 14 for access to the tokenized account numbers. This allows for determination of actual target bank account numbers to allow for ACH payment execution relative thereto.

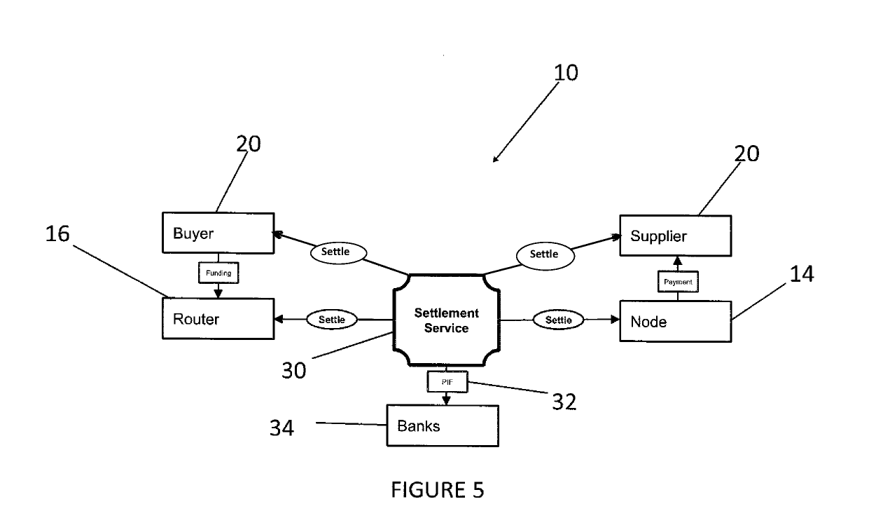

As shown in FIG. 5, settlement of any requested ACH payment may be handled directly between the parties (e.g., through one or more components of the system 10) or through a settlement service 30 which transmits instructions, such as with a settlement payment instruction file 32, to one or more banks 34 for settlement of the ACH payments.

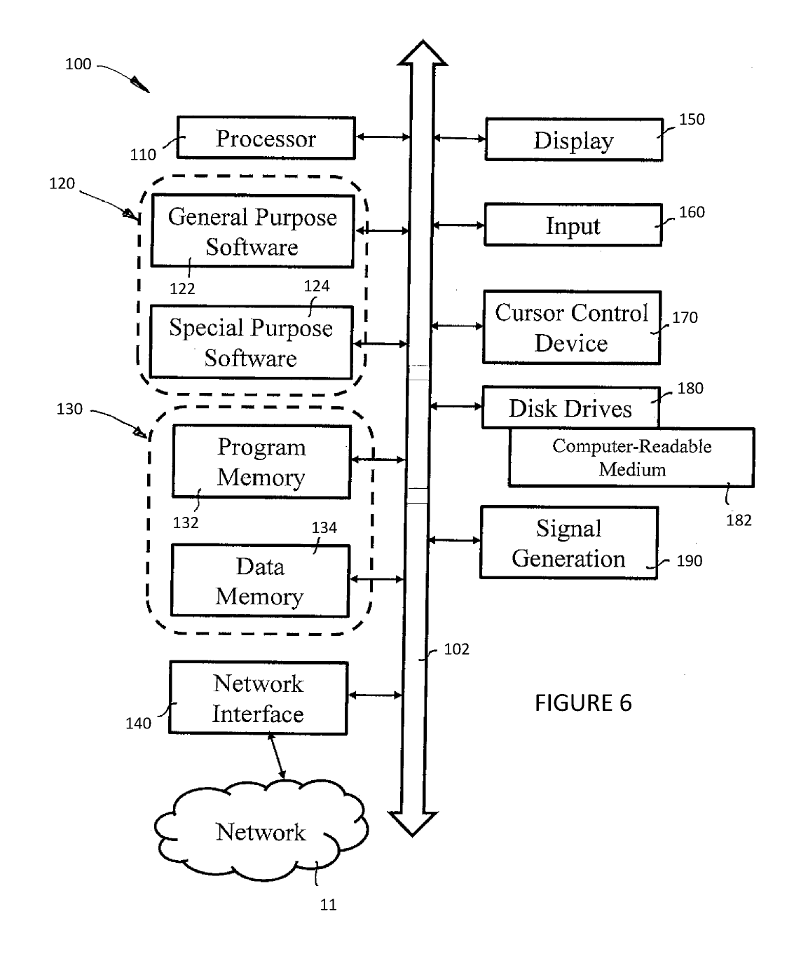

Referring next to FIG. 6, a computing unit 100 in accordance with embodiments of the present invention will now be discussed in more detail. The computing unit 100 may be a general purpose computing device having a plurality of devices and components operably connected over a bus 102. The computing unit 100 has one or more processors 110 or central processing units (“CPU”). Although the computing unit 100 of the present invention is discussed as having a single processor 110, a computing unit having multiple processor, either separate or integrated in a multi-core processor, for example, are also contemplated by and within the scope and spirit of the present invention. Reference to processor in the singular herein shall be interpreted to include any variation and number of processors. The processor 110 is operable by at least one program of instructions 120 comprising general purpose software 122 to carry out functions that enable the computing unit 100 to interface with its various hardware components (discussed further below), and to interface and communicate with other devices. The processor 110 of the present invention is also operable by at least one program of instructions 120 comprising special purpose software 124 to carry out aspects of the present invention. The general purpose software 122 and special purpose software 124 may be stored on the computing unit 100 in memory 130 that may comprise program memory 132 and data memory 134, or it may be stored on one or more disk drives 180 comprised of a computer-readable medium 182, or it may be stored in/on any combination of the foregoing. As used herein, the term “memory” is intended to include all currently known or hereafter developed types of permanent or temporary storage devices or components in a computing device. Exemplary memory types include, by way of illustration and not limitation, Random Access Memory (RAM)—further including Dynamic RAM (DRAM), Static RAM (SRAM), and Direct Rambus DRAM (DRDRAM), Read Only Memory (ROM)—further including Programmable ROM (PROM), erasable PROM (EPROM), and Electrically EPROM (EEPROM), cache memory, hard drives and flash memory.

The computing unit 100 may further include a display 150, input device(s) 160 (e.g., a keyboard), cursor control device(s) 170 (e.g., a mouse), signal generation device(s) 190 (e.g., a speaker or remote control), and network interface device(s) 140 that enable the computing unit 100 to selectively connect to and with the network 11 and send or receive voice, video or data, and to communicate over the network 11 as controlled by the program of instructions 120.

The memory 130 and disk drives 180 each comprise computer-readable medium 182 that may each include a single medium or multiple media (e.g., a centralized or distributed database, and/or associated caches and servers) that store the one or more programs of instructions 120. As used herein, the term “computer-readable medium” means and includes, but is not limited to, solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives that is considered a distribution medium equivalent to a tangible storage medium. Accordingly, the embodiment is considered to include anyone or more of a tangible computer-readable medium or a tangible distribution medium, as listed herein and including art-recognized equivalents and successor media, in which the software implementations herein are stored. The term “computer-readable medium” also means and includes any medium that is capable of storing, encoding, or carrying a set of instructions in the general purpose software 122 and in the special purpose software 124.

Although the present specification may describe components and functions implemented in the embodiments with reference to particular standards and protocols, the disclosed embodiments are not limited to such standards and protocols.

In accordance with various embodiments, the present invention may be implemented as one or more software programs running on one or more computing devices and one or more computer processors. Dedicated hardware implementations including, but not limited to, application specific integrated circuits, programmable logic arrays and other hardware devices can likewise be constructed to implement the present invention. Furthermore, alternative software implementations including, but not limited to, distributed processing or component/object distributed processing, parallel processing, or virtual machine processing can also be constructed to implement the present invention.

As used herein, the term “connectable” refers to various states of connection between electronic devices. For example, “connectable” refers to a physical connection between electronic devices, a wireless connection between electronic devices, a combination of a physical and wireless connection between electronic devices, a transient or episodic connection between electronic devices. As used herein the term “connectable” also refers to various states of connectivity between electronic devices such as, by way of non-limiting example, when electronic devices are not connected, when electronic devices are connecting, and when electronic devices are connected.

Modifications to embodiments of the present invention are possible without departing from the scope of the invention as defined by the accompanying claims. Expressions such as “including,” “comprising,” “incorporating,” “consisting of,” “have,” “is,” used to describe and claim the present invention are intended to be construed in a non-exclusive manner, namely allowing for articles, components or elements not explicitly described herein also to be present. Reference to the singular is to be construed to relate to the plural, where applicable.

Although specific example embodiments have been described, it will be evident that various modifications and changes may be made to these embodiments without departing from the broader scope of the inventive subject matter described herein. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A system for routing ACH payments initiated within vendor-defined ACH payment schemes, the system comprising:
a first vendor-defined ACH payment scheme including one or more central computing units acting as routing agents to facilitate ACH payments by or between enlisted parties;
an electronic payment network which is not publicly accessible, the one or more central computing units being connectable to the electronic payment network;
a first routing computing unit located on the electronic payment network configured to receive, from the one or more central computing units, ACH formatted messages over the electronic payment network initiated within the first vendor-defined ACH payment scheme by one or more of the enlisted parties, the first routing computing unit configured to route the ACH formatted messages over the electronic payment network for further processing; and,
a first node computing unit located on the electronic payment network configured to receive the ACH formatted messages routed by the first routing computing unit, the first node computing unit being configured to facilitate ACH payments to payees designated by the received ACH formatted messages.

2. A system as in claim 1, wherein at least one of the payees is an enlisted party in a second vendor-defined ACH payment scheme.

3. A system as in claim 2, further comprising a module with a look-up table for harmonizing the ACH formatted messages to conform with the second vendor-defined ACH payment scheme.

4. A system as in claim 1, wherein the ACH formatted messages are initiated by the one or more of the enlisted parties using a portal or graphical user interface.

5. A system as in claim 1, wherein the ACH formatted messages contain addenda files.

6. A system as in claim 1, further comprising one or more databases storing details of possible recipients of ACH payments.

7. A system as in claim 6, wherein the first routing computing unit routes the ACH formatted messages based on the stored details of a specified recipient.

8. A system as in claim 1, wherein the first routing computing unit routes the ACH formatted messages based on tokenized account numbers.

9. A system as in claim 1, further comprising a transaction data switch configured to receive payment instruction files from the first routing computing unit and configured to route the payment instruction files to the first node computing unit.

10. A system as in claim 9, wherein the payment instruction files include remittance data in standardized format.

11. A system as in claim 1, further comprising a settlement service for transmitting settlement payment instruction files to one or more banks for the settlement of the ACH payments.

12. A method of routing ACH payments initiated within vendor-defined ACH payment schemes, the method comprising:
tokenizing payee bank details into account numbers;
storing, on a database, the tokenized account numbers;
receiving ACH formatted messages initiated within a first vendor-defined ACH payment scheme, the ACH formatted messages including the tokenized account numbers to designate intended payees; and,
routing the received ACH formatted messages to one or more node computing units, the node computing units being operatively connected to the database to determine, based on the tokenized account numbers, bank details of the intended payees to facilitate ACH payments thereto.

13. A method as in claim 12, further comprising routing the received ACH formatted messages through a transaction data switch configured to route the received ACH formatted messages to the node computing units.

14. A method as in claim 12, further comprising transmitting settlement payment instruction files to one or more banks for settlement of the ACH payments.

15. A method as in claim 12, further comprising conducting a check of the database to determine whether the intended payees are eligible for receipt of the ACH payments.

16. A method as in claim 12, wherein the ACH formatted messages are initiated by one or more parties enlisted in the first vendor-defined ACH payment scheme using a portal or graphical user interface.

17. A method as in claim 12, further comprising harmonizing the received ACH formatted messages to a predefined central standard.

18. A method as in claim 12, further comprising harmonizing the received ACH formatted messages to comply with formatting of an intended recipient vendor-defined ACH payment scheme.
